(19) United States
(12) Patent Application Publication
(10) Pub. No.: US 2004/0119435 A1
(43) Pub. Date: Jun. 24, 2004

(54) Mechanical bug

(76) Inventor: Steve B. Pinney, Canyon Country, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/687,353

(22) Filed: Feb. 17, 2004

Related U.S. Application Data
(60) Provisional application No. 60/426,513, filed on Nov. 14, 2002.

(51) Int. Cl. B25J 5/00

(52) U.S. Cl. 318/568.12; 318/139; 318/16

(57) ABSTRACT

A mechanical bug includes a housing; a gear mechanism within the housing; and at least six legs extending from the housing, each leg having a first end operationally associated with the gear mechanism such that movement of the gear mechanism also moves the leg. The at least three legs move backward in a flat plane while at least three other legs arch upward and forward before returning again in the flat plane, causing the mechanical bug to remain level and steady as the mechanical bug walks forward.

### RELATED APPLICATION

The present application claims priority from U.S. Provisional Application Serial No. 60/426,513, filed Nov. 14, 2002.

### BACKGROUND OF THE INVENTION

The present invention relates generally to walking robots. More particularly, the present invention relates to a mechanical bug having a mechanical movement replicating that of an insect.

While efforts have been directed towards simulated walking and/or turning, the problem of balance has apparently been so resistant to solution that most robots available in the marketplace today employ wheels and/or continuously driven tracks to enable a robot to move over the ground by rolling or gliding.

Nevertheless, while most robots available in the marketplace today employ wheels and/or tracks to permit movement over the ground, the related art is replete with long-standing efforts to provide a robot capable of walking.

There are thousands of mechanical insect toys in the world. Even the simplest windup toys give an effect of insect movement. Most of these toys are designed for ease of manufacture to keep prices down because they are toys and tend to be overly compact for strength and endurance in child's play. The leg movements have not achieved a natural or believable gait regardless of the complexity involved. Most legs will move back and forth or up and down or around in full circles. The bug flops about for effect or wiggles it's legs as it rides around on wheels. For an insect to look natural it's body should seem to float or hover which would require the legs to balance the body as it moves, especially if the legs are weight bearing.

Accordingly, there is a continuing need for a mechanical device that mimics the movement of an insect.

### SUMMARY OF THE INVENTION

The present invention resides in a remote-controlled device having the mechanical movement that replicates a walking insect having six legs. It has been found that for such a device to have a natural insect look it should seem to float or hover, requiring the legs to balance the body as it moves.

This is best achieved with three legs on the ground at all times. Since insects have six legs a mechanical movement is needed that has three legs triangularly placed moving backward in a flat plane and bearing the weight while the opposing three legs arch forward in a semi-circle before returning again in a flat plane, again bearing the weight. The plane is common to the axis of the semi-circle causing the body to remain level and steady as it walks forward.

In accordance with the objects and needs of the present invention, a mechanical bug includes a housing; a gear mechanism within the housing; and at least six legs extending from the housing, each leg having a first end operationally associated with the gear mechanism such that movement of the gear mechanism also moves the leg. The at least three legs move backward in a flat plane while at least three other legs arch upward and forward before returning again in the flat plane, causing the mechanical bug to remain level and steady as the mechanical bug walks forward.

The mechanical bug further includes a first shuttle engaging the gear mechanism on a first side of the housing and a second shuttle engaging the gear mechanism on a second side of the housing, wherein each shuttle engages at least three legs. The first shuttle engages the first end at least one leg on the second side of the housing and the first ends of at least two legs on the first side of the housing, and the second shuttle engages the first end of at least one leg on the first side of the shuttle and the first ends of at least two legs on the second side of the housing.

The gear mechanism includes at least three gears, each of the three gears including a first side, a second side, and two diametrically opposed posts on opposite sides of the gear. The first shuttle engages at least two posts on the first side of the housing and the second shuttle engages at least two posts on the second side of the housing. The posts move the shuttles backwards and forwards as the gears rotate.

Each shuttle includes a plurality of loops. Each loop engages a particular one of the posts. When the gears rotate one full turn, one of the posts on each gear will travel up and down on one side within the confines of one of the loops causing the shuttle to which that particular loop is attached to move forward and backward, and the post on the other side of each gear will move down and up within the confines of another loop causing the shuttle to which that particular loop is attached to move backward and forward.

Each leg includes a second end for contacting a surface. The first end of each leg is inserted into a particular loop of the shuttles such that movement of the shuttles also moves the legs.

The gear mechanism is remote controlled.

Each leg includes a second end for contacting a surface, wherein a first end of each leg engages a particular one of the shuttles such that movement of the shuttles also moves the legs.

The mechanical bug also includes a plurality of brackets connected to first and second sides of the housing. Each leg is pivotally connected to a respective bracket so that each of the brackets provides a point about which the respective leg pivots when moving.

The mechanical bug further includes a means for driving the gear mechanism. The driving means may be a motor. The motor may be battery-powered or, alternatively, the motor may be solar-powered. The driving means may also be a spring-loaded wind-up mechanism.

The gear mechanism includes a plurality of gears, the driving means operationally engaging one of the plurality of gears, thereby causing that particular gear to rotate at least one adjacent gear of the plurality of gears, whereby rotation of the gears causes the legs to move.

Other features and advantages of the present invention will become apparent from the following more detailed description, taken in connection with the accompanying drawing which illustrate, by way of example, the principals of the present invention.

### BRIEF DESCRIPTION OF THE DRAWINGS

The accompanying drawings illustrate the invention. In such drawings:

FIGS. 1 and 2 are orthogonal views of an embodiment of the present invention illustrating a mechanical bug with legs in different positions;

FIG. 3 is a front elevation view of housing cabinet with cylindrical shims fixedly attached to the gear, the rotation of the gears, and the small cylindrical posts on the large gears;

FIG. 4 is a side elevation view of FIG. 3;

FIG. 5 is a view of FIG. 4 further including “T” bars;

FIG. 6 is a top plan view of the embodiment shown in FIG. 5;

FIGS. 7, 8 and 9 illustrate the upper shuttle;

FIGS. 10, 11 and 12 illustrate the lower shuttle which is similar to the upper shuttle but otherwise inverted on its long axis;

FIGS. 13, 14 and 15 illustrate the shuttles at their respective 0°, 90° and 180° positions;

FIG. 16 illustrates the orientation of the shuttles;

FIGS. 17 and 18 illustrate the oar-locks attached to the “T”-bars by brackets;

FIGS. 19 and 20 illustrate one of six identical legs with a fixed pivot pin;

FIGS. 21 and 22 show front elevation and top plan views of the mechanical bug of FIG. 1;

FIG. 23 illustrates a plan view of an oar-lock swivelling within a bracket; taken along line 23-23 of FIG. 21;

FIG. 24 illustrates a leg in an oar-lock and the nature of it's swivel shows oar-lock upheld within a bracket taken along line 24-24 of FIG. 21; and

FIG. 25 illustrates a cross-sectional top plan view of the device shown in FIG. 22.

### DETAILED DESCRIPTION OF THE PREFERRED EMBODIMENT

As shown in the accompanying drawings for purposes of illustration, the present invention resides in a remote-controlled device having mechanical movement that replicates a walking insect having six legs. It has been found that for such a device to have a natural insect look it should seem to float or hover, requiring the legs to balance the body as it moves.

It is the purpose of this invention to provide a remote controlled mechanical bug 10 having movement that replicates a walking insect. It will walk over uneven surfaces and on inclines.

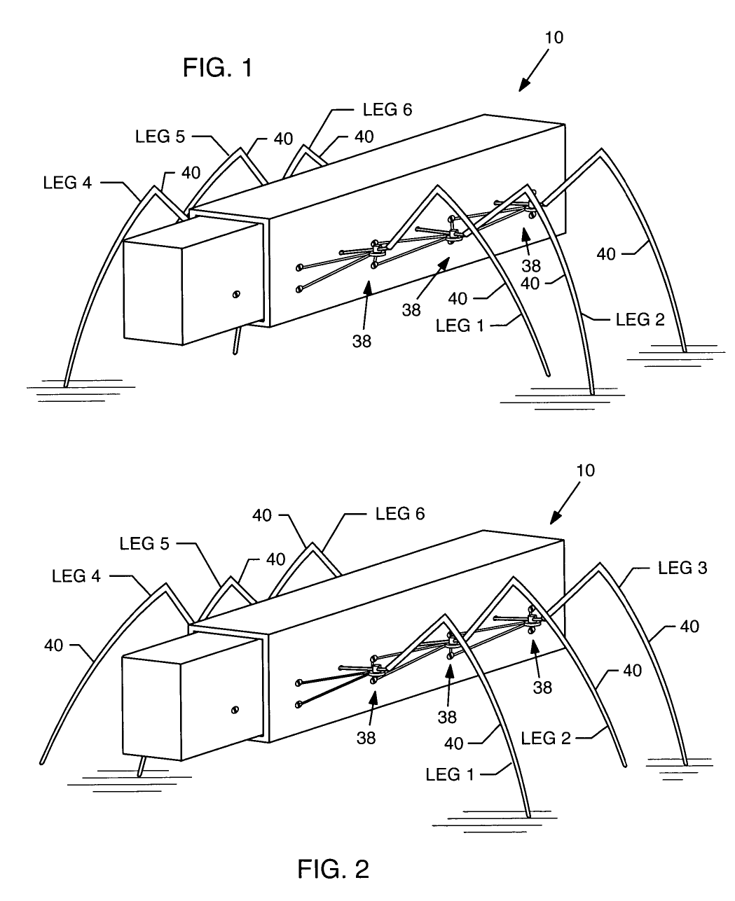

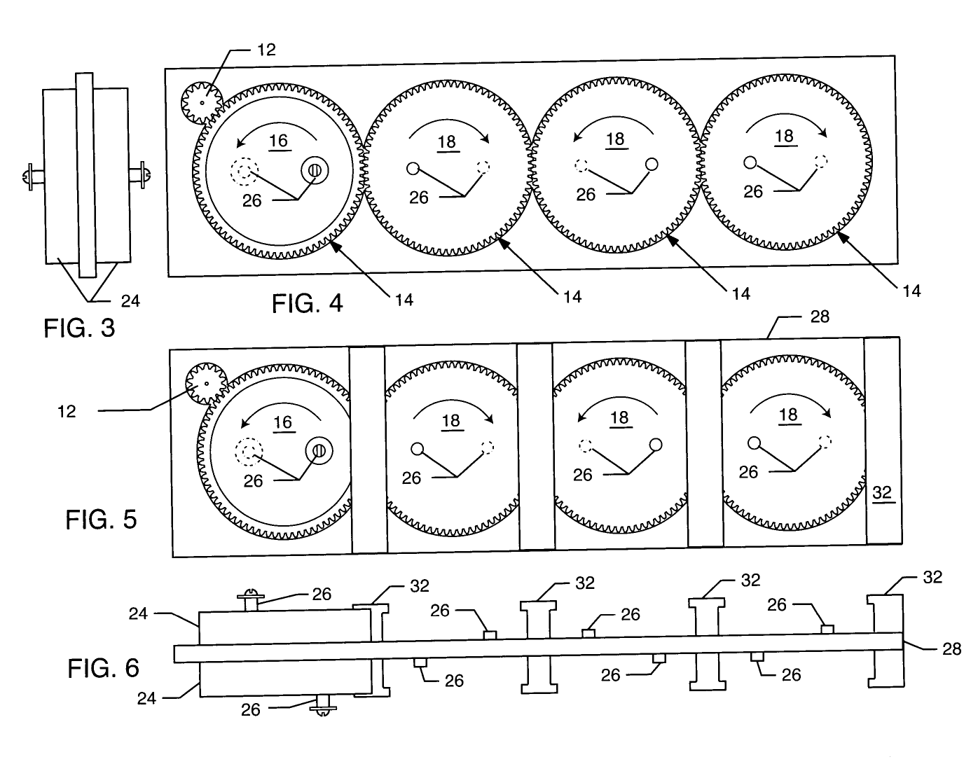

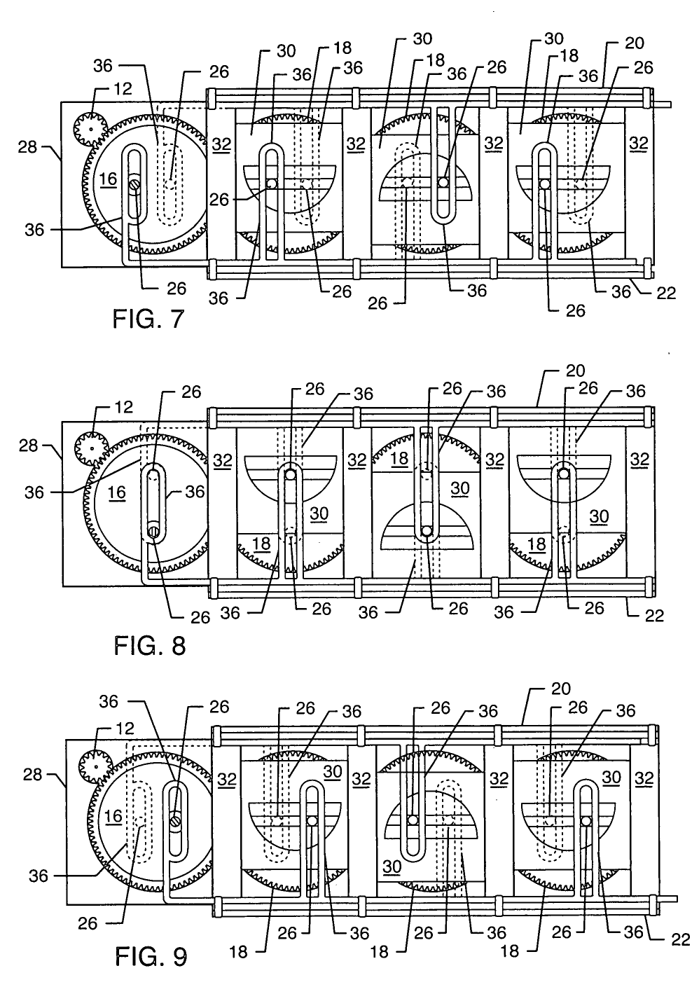

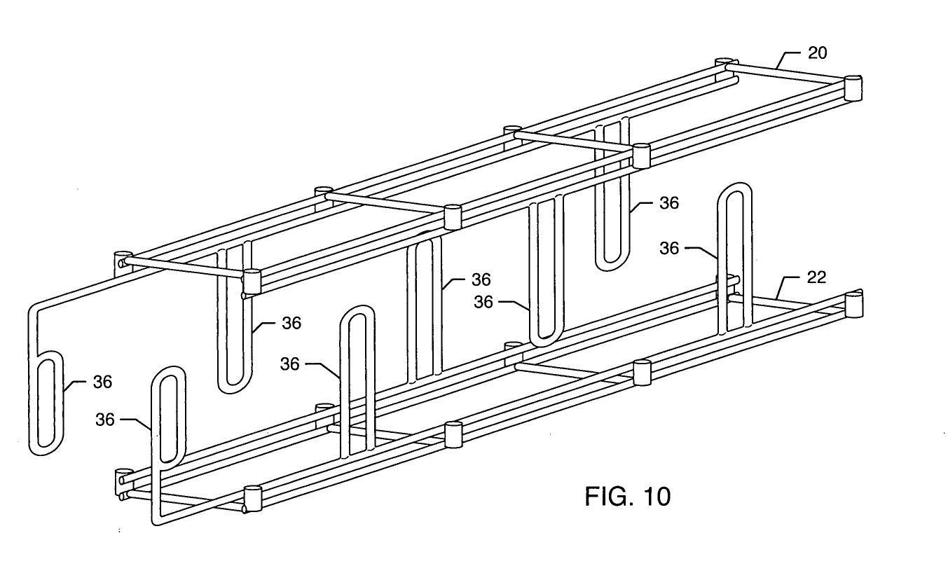

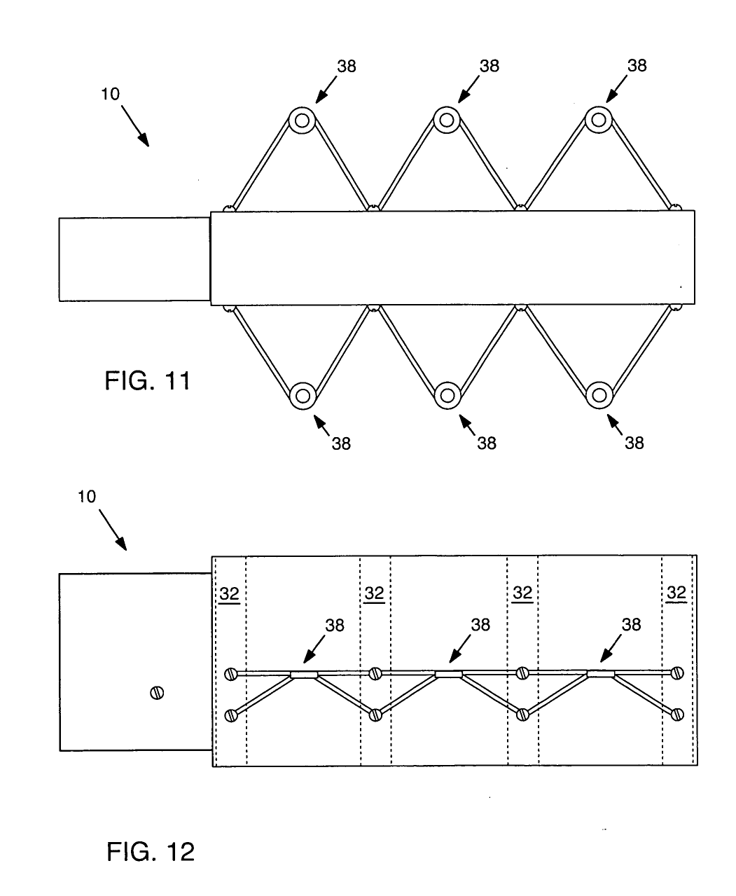

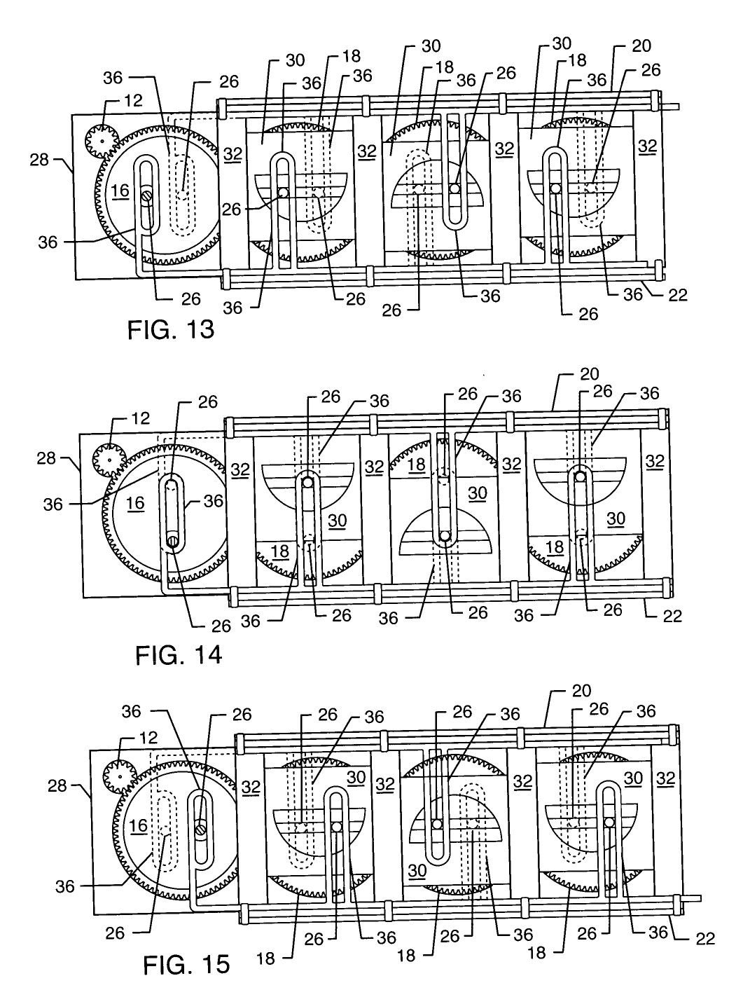

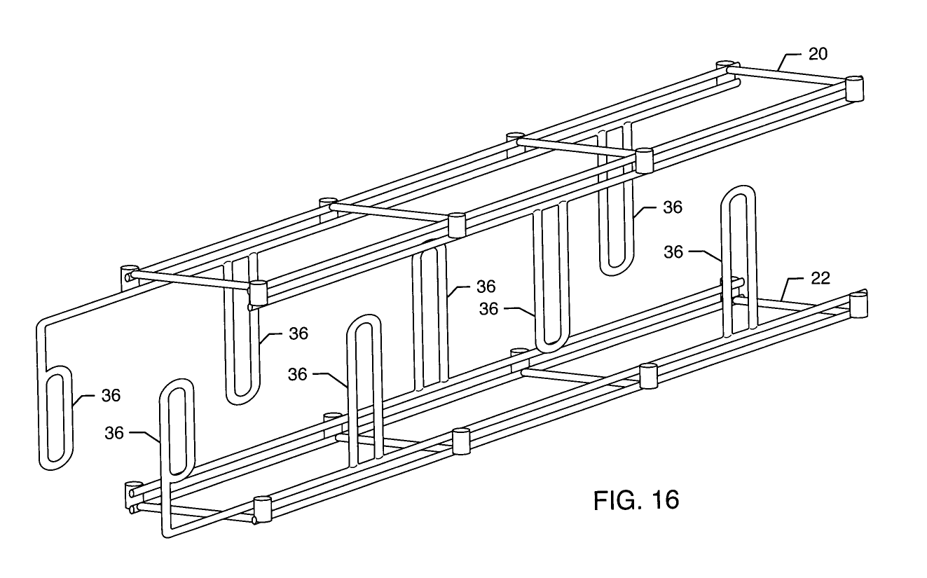

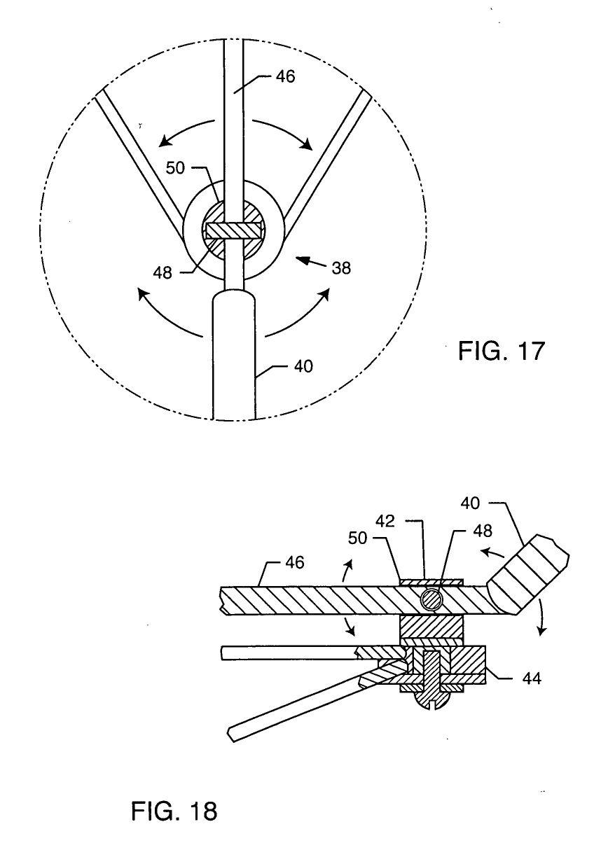

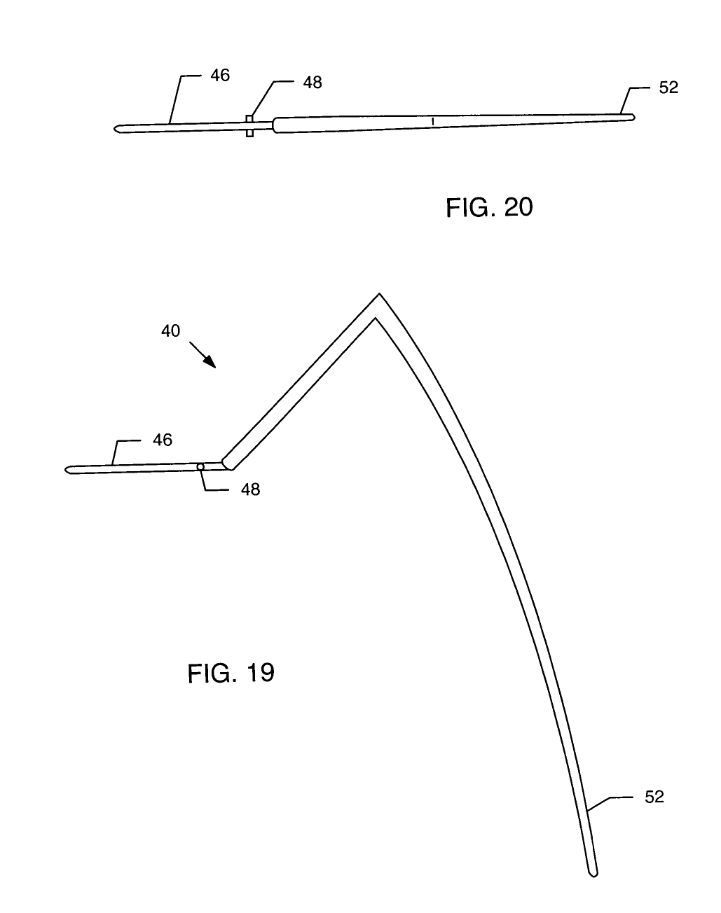

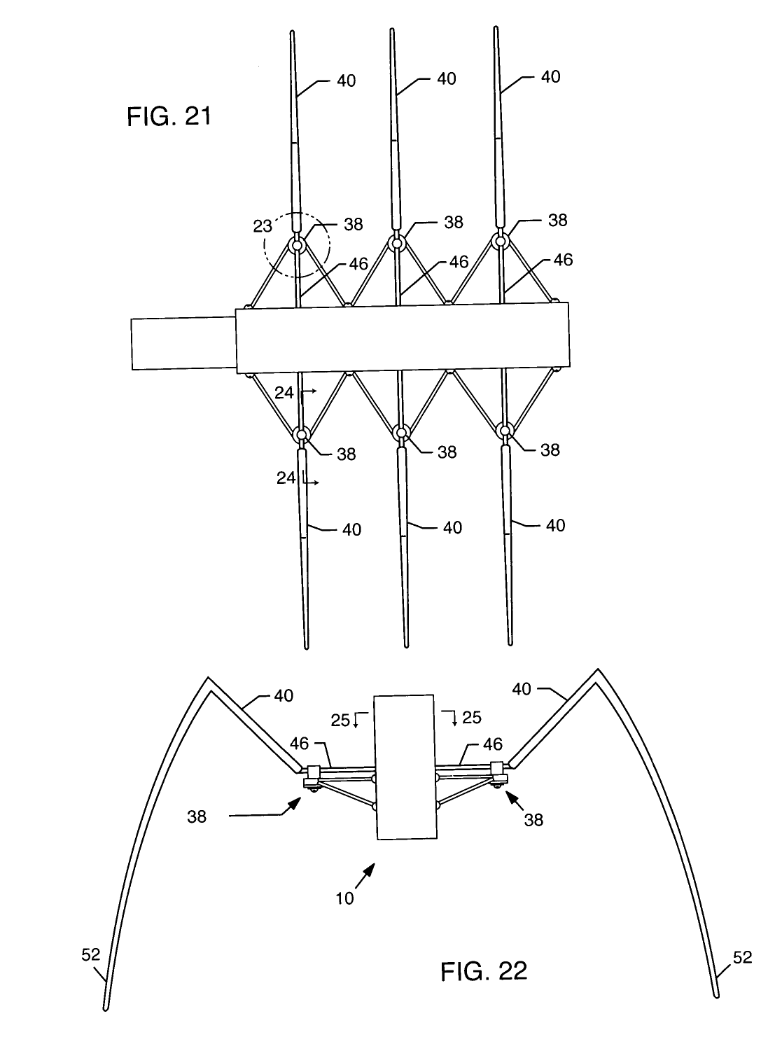

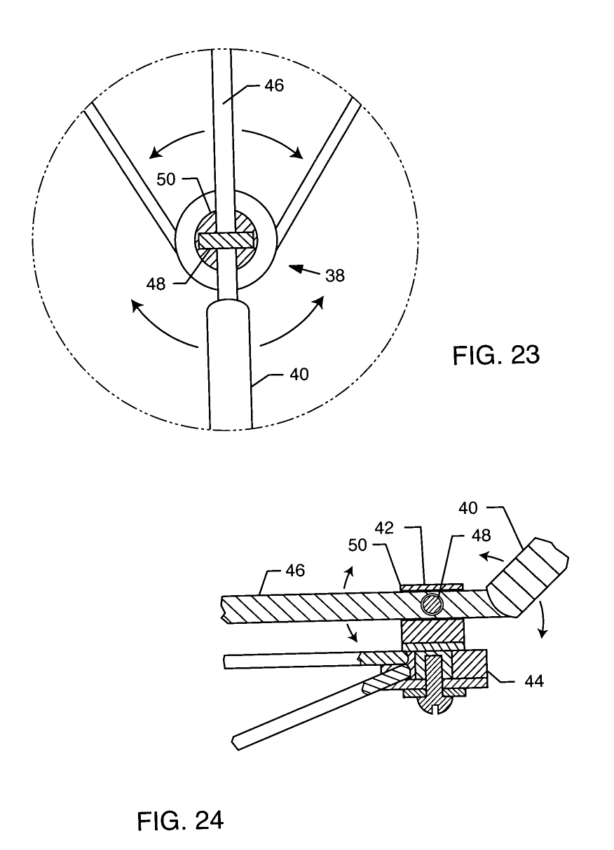

With reference to FIGS. 1-25, the device 10 has five spur gears. One of these gears is a drive gear 12 with sixteen teeth 12. The other four gears 14 each have seventy-two teeth. The drive gear 12 is smaller than the larger gears 14. The four large gears 14 have their axis in a straight line. The large gears 14 includes a push gear 16 and three tile gears 18. As the drive gear 12 rotates clockwise, the next gear (i.e., the push gear 16) rotates counterclockwise, and the tile gear 18 next to the push gear 16 rotates clockwise, causing the adjacent tile gear 18 to rotate counterclockwise, which causes the last tile gear 18 to rotate clockwise, as shown in FIGS. 4 and 5. The push gear 14 drives the last three gears (tile gears) and the two wire shuttles (i.e., the upper shuttle 20 and the lower shuttle 22). Naturally, the direction the gears 12, 14 appear to rotate depends on the orientation of the viewer with respect to the device 10.

A drive mechanism (not shown) connected to the drive gear 12 causes the drive gear 12 to rotate, which in turn causes the other gears 14 to rotate and the shuttles 20, 22 to move. This drive mechanism may be an electric motor that may be battery-powered or, alternatively, the motor may be solar-powered by a solar cell placed on the device 10. The drive mechanism may also be a spring-loaded wind-up mechanism.

The push gear 16 has a cylindrical shim 24 affixed to each of its sides with a smaller cylindrical post 26 affixed to each shim 24. These posts 26 are placed about half way out from the center of the gear 16 and are diametrically opposed. If the post 26 on one side of the push gear 16 is down, the post 26 on the other side of the push gear 16 will be up. Each of the three tile gears 18 have identical posts 26 with identical placement but without the cylindrical shim 24.

The four large gears 14 are about ¼th as thick as they are wide and are confined within but not restricted by a close fitting rectangular cabinet or housing 28 that is slightly thicker than the gears. The four large gears 14 are laid in the device 10 such that the posts 26 on one side of the housing 28 are alternately, down, up, down, and up from back to front. Consequently the posts 26 on the other side of the device 10 will be up, down, up and down.

Six engineered tiles 30 are laid on the three tile gears 18, each with a horizontal slot engaging the post 26 on the respective gears side. Eight “T” bars 32 of the height of the housing 28 are then attached to the housing 28 vertically and centered equidistant from the axis of the tile gears 18. The two “T” bars 32 closest to the push gear 16 are relieved to accept the cylindrical shim 24 on the push gear 16. The “T” bars 32 are the same thickness as the cylindrical shim 24 so as to form a flat plane on both sides of the housing 28.

Rectangular plates 34 are affixed above and below the tiles 30. The plates 34 are nominally wider than the plane described by the “T” bars 32 and act as stiffeners and as slides for the wire shuttles 20, 22.

The shuttles 20, 22 are two identical wire frameworks that loosely engage the posts 26 on each side of the push gear 16 and the slides upon which they are drawn. Each shuttle 20, 22 appears to be inverted on its long axis from the other shuttle 20, 22. Each shuttle 20, 22 has four wire loops 36 set at right angles to the slide on which they are to be drawn in a reciprocating fashion. The rear most loop 36 on each shuttle 20, 22 is loosely attached to the posts 26 of the push gear 16 so that when the push gear 16 is rotated one full turn, the post 26 on one side of the push gear 16 will travel up and down within the confines of the loop 36 of the upper shuttle 20, which causes the upper shuttle 20 to move forward and backward. During this rotation, the corresponding post 26 on the other side of the push gear 16 will move down and up within the confines of the loop 36 causing the lower shuttle 22 to move backward and forward. The remaining three loops 36 on each shuttle 20, 22 will, in the case of the lower shuttle 22, be situated touching the front of the first and third tile 30 on the starboard side and the second tile 30 on the port side. In the case of the upper shuttle 20, the loops 36 will be situated touching the first and third tile 30 on the port side and the second tile 30 on the starboard side. The tiles 30 move vertically upward and downward as the tile gears 18 rotate. As the push gear 16 is rotated via the drive gear 12, the shuttles 20, 22 will reciprocate horizontally, in opposing directions, all at the same rate.

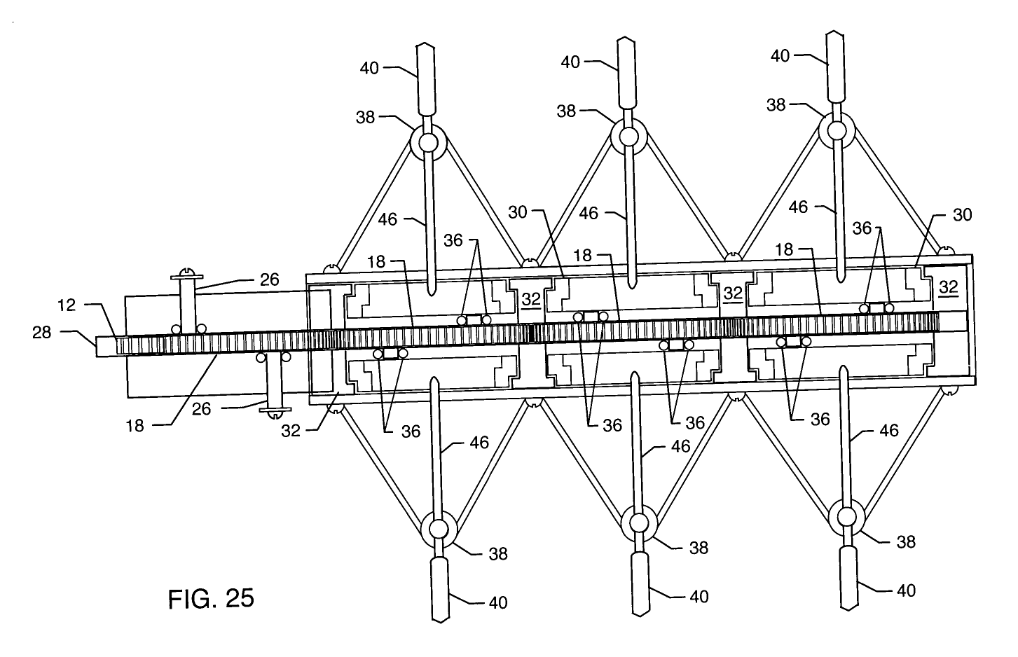

Thus far, a mechanical movement having six tiles 30 with inverted semicircles has been described. Each of these tiles 30 will be assigned an oar-lock bracket 38 and a leg 40. The oar-lock brackets 38 will be fixedly attached by screws to the “T” bars 32 (via threaded bores in the “T” bars 32) between the tiles 30 so as not to encumber the movement of the loops 36 of the shuttles 20, 22. Each leg 40 will swivel on a horizontal pivot 42 which will swivel on a vertical pivot 44 directly beneath. Each oar-lock 38 sits at the same distance from its respective tile 30 and is centered at the axis of that the gear 18 of that particular tile 30. A horizontal wire end 46 of the leg 40 is inserted through its respective wire loop 36 on the shuttle 20, 22 and into the confines of the semicircle almost touching the back wall of the cavity therein, as seen in FIG. 25. The vertical pivot 44 is inserted into the oar-lock 38 and secured so that it cannot lift out, but will swivel. A pin 48 inserted through a bore 50 in the leg 40 secures the leg to the horizontal pivot 42. This is repeated for the other five legs 40. A contact end 52 of the leg 40 contacts the surface the device is traveling on.

When the drive gear 12 is rotated 180° legs 1, 3 and 5 will arch forward as legs 2, 4 and 6 travel backward in a horizontal plane. Further 180° rotation in the same direction causes legs 1, 3 and 5 to return in a horizontal plane and legs 2, 4 and 6 to arch forward thus causing one step forward for every full rotation.

The device 10 may be covered with a decorative facade (not shown) that is meant to mimic the appearance of an insect.

The device 10 is remote controlled by standard remote control units, such as a radio frequency (RF) or Infra-red (IR) controller. Appropriate receiving circuitry is located within the device and electrically, electronically, and mechanically connected to the drive mechanism connected to the drive gear 12. The device 10 may further include a processor with a memory that is capable of storing a series of programmed commands for operating the device 10.

Although the embodiment has been described in detail for purposes of illustration, various modifications may be made without departing from the scope and spirit of the invention. Accordingly, the invention is not to be limited, except as by the appended claims.

What is claimed is:

1. A mechanical bug, comprising:
a housing;
a gear mechanism within the housing; and
at least six legs extending from the housing, each leg having a first end operationally associated with the gear mechanism such that movement of the gear mechanism also moves the leg;
wherein at least three legs move backward in a flat plane while at least three other legs arch upward and forward before returning again in the flat plane, causing the mechanical bug to remain level and steady as the mechanical bug walks forward.

2. The mechanical bug of claim 1, including a first shuttle engaging the gear mechanism on a first side of the housing and a second shuttle engaging the gear mechanism on a second side of the housing, wherein each shuttle engages at least three legs.

3. The mechanical bug of claim 2, wherein the first shuttle engages the first end at least one leg on the second side of the housing and the first ends of at least two legs on the first side of the housing, and the second shuttle engages the first end of at least one leg on the first side of the shuttle and the first ends of at least two legs on the second side of the housing.

4. The mechanical bug of claim 2, wherein the gear mechanism includes at least three gears, each of the three gears including a first side, a second side, and two diametrically opposed posts on opposite sides of the gear, wherein the first shuttle engages at least two posts on the first side of the housing and the second shuttle engages at least two posts on the second side of the housing, whereby the posts move the shuttles backwards and forwards as the gears rotate.

5. The mechanical bug of claim 4, wherein each shuttle includes a plurality of loops, each loop engaging a particular one of the posts, whereby when the gears rotate one full turn, one of the posts on each gear will travel up and down on one side within the confines of one of the loops causing the shuttle to which that particular loop is attached to move forward and backward, and the post on the other side of each gear will move down and up within the confines of another loop causing the shuttle to which that particular loop is attached to move backward and forward.

6. The mechanical bug of claim 5, wherein each leg includes a second end for contacting a surface, and wherein the first end of each leg is inserted into a particular loop of the shuttles such that movement of the shuttles also moves the legs.

7. The mechanical bug of claim 1, wherein the gear mechanism is remote controlled.

8. The mechanical bug of claim 2, wherein each leg includes a second end for contacting a surface, wherein a first end of each leg engages a particular one of the shuttles such that movement of the shuttles also moves the legs.

9. The mechanical bug of claim 1, including a plurality of brackets connected to first and second sides of the housing, wherein each leg is pivotally connected to a respective bracket, whereby each of the brackets provides a point about which the respective leg pivots when moving.

10. The mechanical bug of claim 1, including means for driving the gear mechanism.

11. The mechanical bug of claim 10, wherein the gear mechanism includes a plurality of gears, the driving means operationally engaging one of the plurality of gears, thereby causing that particular gear to rotate at least one adjacent gear of the plurality of gears, whereby rotation of the gears causes the legs to move.

12. The mechanical bug of claim 10, wherein the driving means is a motor.

13. The mechanical bug of claim 12, wherein the motor is battery-powered.

14. The mechanical bug of claim 12, wherein the motor is solar-powered.

15. The mechanical bug of claim 10, wherein the driving means is a spring-loaded wind-up mechanism.

16. A mechanical bug, comprising:
a housing;
a gear mechanism within the housing;
at least six legs extending from the housing, each leg having a first end operationally associated with the gear mechanism such that movement of the gear mechanism also moves the leg;
a first shuttle engaging the gear mechanism on a first side of the housing, and a second shuttle engaging the gear mechanism on a second side of the housing, wherein each shuttle engages at least three legs; and
means for driving the gear mechanism;
wherein at least three legs move backward in a flat plane while at least three other legs arch upward and forward in a semi-circle before returning again in the flat plane, wherein the plane is common to an axis of the semi-circle, causing the mechanical bug to remain level and steady as the mechanical bug walks forward.

17. The mechanical bug of claim 16, wherein the first shuttle engages the first end at least one leg on the second side of the housing and the first ends of at least two legs on the first side of the housing, and the second shuttle engages the first end of at least one leg on the first side of the shuttle and the first ends of at least two legs on the second side of the housing.

18. The mechanical bug of claim 16, wherein the gear mechanism includes at least three gears, each of the three gears including a first side, a second side, and two diametrically opposed posts on opposite sides of the gear, wherein the first shuttle engages at least two posts on the first side of the housing and the second shuttle engages at least two posts on the second side of the housing, whereby the posts move the shuttles backwards and forwards as the gears rotate.

19. The mechanical bug of claim 16, wherein the gear mechanism is remote controlled.

20. The mechanical bug of claim 16, wherein each leg includes a second end for contacting a surface, wherein a first end of each leg engages a particular one of the shuttles such that movement of the shuttles also moves the legs.

21. The mechanical bug of claim 16, including a plurality of brackets connected to first and second sides of the housing, wherein each leg is pivotally connected to a respective bracket, whereby each of the brackets provides a point about which the respective leg pivots when moving.

22. The mechanical bug of claim 16, wherein the gear mechanism includes a plurality of gears, the driving means operationally engaging one of the plurality of gears, thereby causing that particular gear to rotate at least one adjacent gear of the plurality of gears, whereby rotation of the gears causes the legs to move.

23. A mechanical bug, comprising:
a housing;
a gear mechanism within the housing;
at least six legs extending from the housing, each leg having a first end operationally associated with the gear mechanism such that movement of the gear mechanism also moves the leg;
a first shuttle engaging the gear mechanism on a first side of the housing, and a second shuttle engaging the gear mechanism on a second side of the housing, wherein each shuttle engages at least three legs;
a plurality of brackets connected to first and second sides of the housing wherein each leg is pivotally connected to a respective bracket, whereby each of the brackets provides a point about which the respective leg pivots when moving; and
means for driving the gear mechanism;
whereby at least three legs move backward in a flat plane while at least three other legs arch upward and forward in a semi-circle before returning again in the flat plane, wherein the plane is common to an axis of the semi-circle, causing the mechanical bug to remain level and steady as the mechanical bug walks forward, and wherein the mechanical bug is remote controlled.

24. The mechanical bug of claim 23, wherein the first shuttle engages the first end at least one leg on the second side of the housing and the first ends of at least two legs on the first side of the housing, and the second shuttle engages the first end of at least one leg on the first side of the shuttle and the first ends of at least two legs on the second side of the housing.

25. The mechanical bug of claim 23, wherein the gear mechanism includes at least three gears, each of the three gears including a first side, a second side, and two diametrically opposed posts on opposite sides of the gear, wherein the first shuttle engages at least two posts on the first side of the housing and the second shuttle engages at least two posts on the second side of the housing, whereby the posts move the shuttles backwards and forwards as the gears rotate.

26. The mechanical bug of claim 23, wherein each leg includes a second end for contacting a surface, wherein a first end of each leg engages a particular one of the shuttles such that movement of the shuttles also moves the legs.

27. The mechanical bug of claim 23, wherein the gear mechanism includes a plurality of gears, the driving means operationally engaging one of the plurality of gears, thereby causing that particular gear to rotate at least one adjacent gear of the plurality of gears, whereby rotation of the gears causes the legs to move.
